(19) United States
(12) Patent Application Publication
(10) Pub. No.: US 2020/0050865 A1
(43) Pub. Date: Feb. 13, 2020

(54) METHOD AND SYSTEM FOR DETECTING A RAISED OBJECT LOCATED WITHIN A PARKING AREA

(71) Applicant: Robert Bosch GmbH, Stuttgart (DE)

(72) Inventors: Andreas Lehn, Ludwigsburg (DE); Felix Hess, Benningen (DE); Stefan Nordbruch, Kornwestheim (DE)

(21) Appl. No.: 16/346,211

(22) PCT Filed: Sep. 27, 2017
(86) PCT No.: PCT/EP2017/074436

§ 371 Date: Apr. 30, 2019

(30) Foreign Application Priority Data
Nov. 23, 2016 (DE) 102016223185.5

(51) Int. Cl. G06K 9/00; G06T 7/70; G08G 1/04; G08G 1/0967

(52) U.S. Cl. CPC G06K 9/00711; G06K 9/00771; G06K 2009/2045; G08G 1/04; G08G 1/096708; G06T 7/70

(57) ABSTRACT

A method for detecting a raised object located within a parking area, using at least two video cameras, which are spatially distributed inside of the parking area, and whose respective visual ranges overlap in an overlapping region; the method including the following steps: recording respective video images of the overlapping region, using the video cameras; analyzing the recorded images, in order to detect a raised object in the recorded video images; the analyzing being carried out exclusively by at least one of the video cameras, inside of the video camera(s). A corresponding system, a parking area and a computer program are also described.

### BACKGROUND INFORMATION

The present invention relates to a method for detecting a raised object located within a parking area, for example, a parking garage, in particular, within a travel route envelope of a parking area. The present invention further relates to a system for detecting a raised object located within a parking area, for example, a parking garage, in particular, within a travel route envelope of a parking area. In addition, the present invention relates to a parking area. Furthermore, the present invention relates to a computer program.

German Patent Application No. DE 10 2015 201 209 A1 describes a valet parking system for automatically taking a vehicle from a handover zone to an assigned parking space within a specified parking area. This system includes a parking area monitoring system having at least one stationary-mounted sensor unit. The parking area monitoring system is configured to locate the vehicles traveling within the specified parking area.

### SUMMARY

An object of the present invention is to provide for efficiently detecting a raised object located within a parking area, for example, a parking garage, in particular, within a travel route envelope of a parking area.

This object may be achieved in accordance with the present invention. Advantageous refinements of the present invention are described herein.

According to one aspect of the present invention, an example method is provided for detecting an object located within a parking area, using at least two video cameras, which are spatially distributed within the parking area, and whose respective visual ranges overlap in an overlapping region. The example method includes the following steps:
recording respective video images of the overlapping region, using the video cameras;
analyzing the recorded images, in order to detect a raised object in the recorded video images;
the analyzing being carried out exclusively by at least one of the video cameras, inside of the video camera(s).

According to another aspect of the present invention, an example system for detecting a raised object located within a parking area is provided. The example system is configured to execute the method for detecting a raised object located within a parking area.

According to another aspect of the present invention, an example parking area is provided, which includes the system for detecting a raised object located within a parking area.

According to another aspect of the present invention, an example computer program is provided, which includes program code for carrying out the method for detecting a raised object located within a parking area, when the computer program is executed on a computer, in particular, on a processor of a video camera.

The present invention is based on the analysis of the recorded video images being carried out exclusively inside of the video camera, that is, in one or in a plurality of the video cameras themselves. An alternative or additional analysis of the recorded video images with the aid of an external processing unit, which is different from the video cameras, is not provided.

This produces the technical advantage, that the video cameras may be used efficiently: recording the video images and analyzing the video images. Thus, the video cameras have a dual function.

This produces, in particular, the technical advantage that an additional, external processing unit may be dispensed with. Installation, operation and maintenance of such an external processing unit are generally complex, time-intensive and cost-intensive. The design of the present invention advantageously eliminates these disadvantages.

This therefore produces the technical advantage that a design for efficiently detecting a raised object located within a parking area may be provided.

In particular, redundancy is brought about by using at least two video cameras. In particular, faults of a video camera may be compensated for by the other video camera.

A technical advantage of this is, for example, that false alarms may be reduced or prevented, which advantageously permits efficient operation of the parking area, and which allows, for example, efficient operation of motor vehicles traveling driverlessly within the parking area.

This produces, for example, the technical advantage that objects may be detected efficiently, so that a collision with such objects may be prevented.

The wording “at least one of the video cameras” includes, in particular, the following phrases: “exclusively one of the video cameras,” “exactly one of the video cameras,” “a plurality of video cameras,” and “all of the video cameras.” Thus, this means that, in particular, the analysis is carried out in one, in particular, exclusively one, or in a plurality of video cameras. Therefore, the analysis is carried out with the aid of one or with the aid of a plurality of video cameras.

To carry out the analysis, the corresponding video camera includes, for example, a processor, which is configured to analyze the recorded video images, in order to detect a raised object in the recorded video images.

For example, a video image processing program runs on the processor.

The processor is configured, for example, to execute a video image processing program.

In the spirit of the description, a parking area is, in particular, a parking area for motor vehicles. The parking area is, for example, a parking garage. An object to be detected is located, for example, within a travel route envelope of the parking area.

A raised object denotes, in particular, an object, whose height relative to the ground of the parking area is at least 10 cm.

The raised object is located, for example, on the ground of the parking area, for example, on a roadway or within a travel region, that is, for example, within a travel route envelope, of the parking area. The raised object is located, for example, within a travel route envelope of the parking area.

According to one specific embodiment, the following steps are provided for detecting a raised object in the recorded video images in accordance with the analysis:
rectifying the recorded video images;
comparing the specific, rectified video images to each other, in order to recognize a difference in the recorded overlapping regions;
detecting a raised object on the basis of the comparison.

Thus, it is provided, in particular, that prior to comparison of the video images, the video images be transformed to the bird's-eye perspective, that is, rectified. The rectified video images are then compared to each other.

If all of the rectified video images of the overlapping region do not have any differences, that is, are the same or identical, or have differences, which differ, at most, by a predetermined tolerance value, then it may be assumed that no raised object is situated in the specific line of sight between the overlapping region and the video cameras. If, however, a raised object is situated in a line of sight between the overlapping region and one of the video cameras, then this one video camera does not see the same as the other video cameras. Thus, the corresponding, rectified video image will differ from the rectified video image of the other video cameras by a difference greater than the predetermined tolerance value. Consequently, a raised object may be detected efficiently.

Rectification of the recorded video images includes or, in particular, is, for example, a transformation of the recorded video images to the bird's-eye perspective. Thus, this means that, in particular, the recorded video images are transformed, for example, to the bird's-eye perspective. This advantageously allows the subsequent comparison to be carried out particularly efficiently.

In the sense of this description, the phrases “the same image information” or “identical image information” or “the same video images” or “identical video images” also include the case, that the image data or the video images differ, at most, by a predetermined tolerance value. Only differences, which are greater than the predetermined tolerance value, result in the detection of an object. Thus, this means, in particular, that small differences in the brightness information and/or color information are permissible for making the statement that the image information or the video images is or are the same or identical, as long as the differences are less than the predetermined tolerance value.

Thus, this means, in particular, that, for example, a raised object is not detected until, for example, the video images differ by a difference, which is greater than the predetermined tolerance value. Thus, this means, in particular, that, for example, a raised object is not detected until, for example, an overlapping region differs from the other overlapping regions by a difference, which is greater than the predetermined tolerance value.

According to one specific embodiment, if the analyzing is carried out with the aid of a plurality of video cameras, each of the video cameras analyzes the recorded video images independently of each other.

In this manner, for example, there is the technical advantage that redundancy is provided efficiently. Thus, each of the video cameras will provide, in particular, a separate result of the analysis. Even if one of the video cameras should fail, a result of the analysis is available on the other video cameras. Thus, this means that even in the case of a malfunction of a video camera, a raised object may still be detected.

In the spirit of the description, a result of the analysis indicates, in particular, whether or not a raised object has been detected in the recorded video images.

In one specific embodiment, a plurality of video cameras are spatially distributed inside of the parking area; at least two video cameras being selected from the plurality of video cameras as the video cameras to be used, whose respective visual ranges overlap in the overlapping region.

According to this specific embodiment, more than two video cameras are spatially distributed within the parking area. In particular, the knowledge of which video camera covers which region of the parking area is available. To cover a region of the parking area, at least two video cameras, which each can see, that is, cover, a common region, the overlapping region, are selected from the plurality of video cameras.

The selected video cameras record video images of the overlapping region, which are analyzed in order to detect a raised object.

By selecting at least two video cameras, which monitor a common region, in this case, the overlapping region, reliable and robust detection of a raised object may particularly be carried out.

This therefore produces, for example, the technical advantage, that a raised object located within the parking area may be detected efficiently.

In particular, redundancy is brought about by using at least two video cameras. In particular, faults of a video camera may be compensated for by the other video camera.

A technical advantage of this is, for example, that false alarms may be reduced or prevented, which advantageously permits efficient operation of the parking area, and which allows, for example, efficient operation of motor vehicles traveling driverlessly within the parking area.

This produces, for example, the technical advantage that objects may be detected efficiently, so that a collision with such objects may be prevented.

In one specific embodiment, it is provided that the analyzing of the recorded video images be carried out by one or more of the selected video cameras, inside of the video camera(s). In particular, the analysis is carried out with the aid of all of the selected video cameras. In particular, the analysis is carried out exclusively with the aid of one or with the aid of a plurality of the selected video cameras.

A technical advantage of this is, for example, that the video images do not have to be transmitted to video cameras not selected.

According to a further specific embodiment, it is provided that the analyzing of the recorded video images be carried out with the aid of one or more of the non-selected video cameras, inside of the video camera(s). In particular, the analysis is carried out with the aid of all of the non-selected video cameras. In particular, the analysis is carried out exclusively with the aid of one or with the aid of a plurality of the non-selected video cameras.

A technical advantage of this is, for example, that the non-selected video cameras are efficiently used for detecting a raised object.

In one specific embodiment, it is provided that the analyzing of the recorded video images be carried out both with the aid of one or more of the selected video cameras, inside of the video camera(s), and with the aid of one or more of the non-selected video cameras, inside of the video camera(s).

According to one specific embodiment, the wording “at least two video cameras” means at least three video cameras.

According to one specific embodiment, the video cameras communicate among each other wirelessly and/or by wire.

In particular, the video cameras are interconnected by a communications network, so as to be able to communicate, using communications technology.

A communications network includes, for example, a WLAN and/or a cellular communications network. Wireless communication includes, for example, communication according to a wireless communications technology, such as WLAN and/or cellular radio communication.

A communications network includes, for example, an ethernet and/or a bus communications network. Wired communication includes, for example, communication according to a wired communications technology, such as ethernet and/or bus communications technology.

In one specific embodiment, the video cameras communicate among themselves, in order to decide, with the aid of which video camera or which of the video cameras the analyzing of the recorded video images is carried out.

This produces, for example, the technical advantage that computing capacity external to the video cameras does not have to be provided for this decision.

In one alternative specific embodiment, which video camera or which of the video cameras are used to carry out the analysis of the recorded video images, is stipulated outside of the video cameras.

This produces, for example, the technical advantage that computing capacity internal to the video cameras does not have to be provided for this decision.

According to one specific embodiment, the video cameras communicate among themselves, in order to transmit the specifically recorded video images to the video camera(s), with the aid of which the analysis is carried out.

A technical advantage of this is, for example, that the recorded video images are provided efficiently to the video camera(s), with the aid of which the analysis is carried out.

In one specific embodiment, a result of the analysis is transmitted to a parking area management server of the parking area, via a communications network.

This produces, for example, the technical advantage that the parking area management server may efficiently operate the parking area on the basis of the result.

According to one specific embodiment, in the case of more than two video cameras, whose respective visual ranges overlap in the overlapping region, the selection of the at least two video cameras from the more than two video cameras includes a random selection of one or more video cameras from the more than two video cameras.

This produces the technical advantage that, for example, statistical errors may be compensated for efficiently.

According to another specific embodiment, in the case of more than two video cameras, whose respective visual ranges overlap in the overlapping region, the selection of the at least two video cameras from the more than two video cameras includes a selection of one or more video cameras from the more than two video cameras, whose respective, medium visual range that includes the center of the specific visual range, is encompassed by the overlapping region.

A technical advantage of this is, for example, that image defects of objectives of the video cameras, which, as a rule, occur preferentially in the edge region of the objective, may not invalidate or hinder the analysis of the video images.

In another specific embodiment, in the case of more than two video cameras, whose respective visual ranges overlap in the overlapping region, the selection of the at least two video cameras from the more than two video cameras includes a selection of a plurality of video cameras from the more than two video cameras, which are situated directly adjacent to each other.

This produces, for example, the technical advantage that the overlapping region may be covered efficiently.

According to another specific embodiment, in the case of more than two video cameras, whose respective visual ranges overlap in the overlapping region, the selection of the at least two video cameras from the more than two video cameras includes a selection of a plurality of video cameras from the more than two video cameras, which record the overlapping region from, in each instance, opposite sides.

A technical advantage of this is, for example, that raised objects may be covered from different perspectives, which means that these may be detected efficiently in the analysis.

According to one specific embodiment, in the case of more than two video cameras, whose respective visual ranges overlap in the overlapping region, the selection of the at least two video cameras from the more than two video cameras includes a selection of one or more video cameras from the more than two video cameras, which have a particular minimum resolution and/or a particular processing time for processing the recorded video images.

This produces, for example, the technical advantage that the overlapping region may be covered efficiently. A technical advantage of this is, for example, that the analysis may be carried out efficiently.

According to a further specific embodiment, in the case of more than two video cameras, whose respective visual ranges overlap in the overlapping region, the selection of the at least two video cameras from the more than two video cameras includes a selection of one or more video cameras from the more than two video cameras, which are optimally calibrated among themselves.

This produces, for example, the technical advantage that the overlapping region may be covered efficiently. A technical advantage of this is, for example, that the analysis may be carried out efficiently.

According to one specific embodiment, in the case of more than two video cameras, whose respective visual ranges overlap in the overlapping region, the selection of the at least two video cameras from the more than two video cameras includes a selection of one or more video cameras from the more than two video cameras, whose video images may be analyzed in a predetermined minimum time.

This produces, for example, the technical advantage that the analysis may be carried out efficiently and rapidly.

In a further specific embodiment, in the case of more than two video cameras, whose respective visual ranges overlap in the overlapping region, exactly two video cameras are selected from the more than two video cameras.

This produces, for example, the technical advantage that the overlapping region may be covered efficiently. A technical advantage of this is, for example, that the analysis may be carried out efficiently and rapidly, in so far as only video images from two video cameras are to be analyzed, in comparison with an analysis from video images of more than two video cameras.

According to one specific embodiment, in the case of more than two video cameras, whose respective visual ranges overlap in the overlapping region, all of the more than two video cameras are initially selected; the video images of the initially selected video cameras, on the basis of which an analysis of the recorded video images has yielded a correct result, being ascertained over time; only video cameras, whose video images were the basis of an analysis that had yielded a correct result, then being selected for the one overlapping region.

This produces, for example, the technical advantage that the video cameras, which are best suited for detecting a raised object safely and reliably in a particular region of the parking area, may be ascertained efficiently.

According to one specific embodiment, in the case of more than two video cameras, whose respective visual ranges overlap in the overlapping region, all of the more than two video cameras are selected.

This produces, for example, the technical advantage that the overlapping region may be covered efficiently. A technical advantage of this is, for example, that a high level of redundancy and an accompanying reduction, in particular, a minimization, of errors may be brought about.

In another specific embodiment, if, within the scope of the analysis, an interim result is ascertained, which has a predefined minimum probability of being correct, the analysis is aborted irrespective of whether or not all of the video images are analyzed, which means that the analysis is also aborted, if all of the video images have not yet been analyzed.

A technical advantage of this is, for example, that the analysis may be carried out efficiently. This produces, for example, the technical advantage that a processor loading for the analysis may be reduced efficiently.

In one specific embodiment, it is provided that the respective video images of the video cameras be analyzed in succession, that is, not concurrently; an aborting criterion being stipulated; upon the presence of the aborting criterion, the analysis of the video images being interrupted, even if not all of the video images have been analyzed.

An example of an aborting criterion is that if, after x (adjustable value) analyses of the respective video images of the selected video cameras, an interim result, which has a predetermined minimum probability of being correct, is ascertained y times (adjustable value), then the analysis of the respective video images of the remaining video cameras is aborted. Thus, the analysis is aborted early, when the aborting criterion is satisfied.

This always applies, for example, to a position (for example, 1 pixel, and/or the smallest physical unit, for example, 1 cm by 1 cm) and/or to a contiguous region (for example, 5 pixels by 5 pixels and/or 5 cm by 5 cm). If, for example, in a region (for example, x pixels by x pixels, or in cm, thus, x cm by x cm) of the specific video images, the image areas are “the same” or “not the same” (->terminating criterion), then, in particular, aborting is carried out. This aborting criterion may be applied to different areas. The smaller the area, the more exact, but also the more computationally intensive it is. This means that a particular area (x pixels by x pixels or x cm by x cm) is set in the video images (when the area is specified in pixels) or in the real world (when specified in cm); if the specific analyses of these areas in the video images yield an equal result (“the same” or “not the same,” thus, different), then, in particular, the analysis being aborted and not continued.

In this context, the number and the selection of the individual views (video cameras) is, for example, different for each position or area.

According to one specific embodiment, it is ascertained, for the first time, which video camera may record which region of the parking area; a result of the first-time determination being checked by repeating the determination as to which of the video cameras may record which region of the parking area.

This produces, for example, the technical advantage that the overlapping region may be covered efficiently. A technical advantage of this is, for example, that changes to the video camera positions may be detected efficiently and then taken into account, as well. This produces, for example, the technical advantage that manufacturing tolerances of the video cameras, which result in, for example, a change in a position of the field of view, may be reacted to efficiently.

In one specific embodiment, prior to each analysis of recorded video images, the result of the first determination is checked for at least the video cameras, whose video images are supposed to be analyzed.

A technical advantage of this is that, for example, changes in the video camera positions may be efficiently prevented from being able to invalidate or hinder the analysis.

According to one specific embodiment, the overlapping region relative to at least one video camera is illuminated differently in comparison with the other video cameras.

This produces, for example, the technical advantage that an object may be detected efficiently. For, if one side of the object is illuminated preferentially or differently from other sides of the object, then differences in the recorded video images may be detected particularly easily and efficiently in an efficient manner.

The fact that the overlapping region relative to at least one video camera is illuminated differently in comparison with the other video cameras means that, for example, a light source, which illuminates the overlapping region from the direction of the at least one video camera, is situated within the parking area. For example, no illumination, that is, no additional light sources, are provided from the directions of the other video cameras, or different sources of illumination are provided, for example, light sources, which are operated at different luminous intensities.

According to one specific embodiment, the overlapping region includes a traveling region for motor vehicles.

This produces, for example, the technical advantage that the traveling region may be monitored efficiently.

According to one specific embodiment, the comparison includes comparing a specific brightness of the rectified video images, in order to recognize differences in brightness as a difference.

This produces, for example, the technical advantage that differences in the recorded overlapping regions may be detected efficiently.

According to one specific embodiment, the parking area is equipped or configured to execute or implement the method for detecting a raised object located within a parking area.

According to one specific embodiment, the method for detecting a raised object located within a parking area is executed or implemented by the system for detecting a raised object located within a parking area.

Technical functionalities of the system are derived analogously from corresponding technical functionalities of the method, and vice versa.

This therefore means, in particular, that system features are derived from corresponding method features, and vice versa.

According to one specific embodiment, at least n video cameras are provided, where n is greater than or equal to 3.

According to one specific embodiment, a lighting unit is provided. The lighting unit is configured to illuminate the overlapping region differently relative to at least one video camera, in comparison with the other video cameras.

The lighting unit includes, for example, one or more light sources, which are positioned so as to be spatially distributed within the parking area. The light sources are positioned, for example, in such a manner, that the overlapping region is variably illuminated from different directions.

In one specific embodiment, the overlapping region is illuminated from a preferred direction in the manner of a spotlight, for example, with the aid of the lighting unit.

In one specific embodiment, the overlapping region is illuminated from one single direction.

The light sources are positioned, for example, on a ceiling or on a column or on a wall or, in general, on an infrastructure element, of the parking area.

According to one specific embodiment, at least n video cameras are used, where n is greater than or equal to 3.

According to one specific embodiment, a specific overlapping region is monitored by exactly three or by exactly four video cameras, whose respective visual ranges overlap in the respective overlapping region.

In one specific embodiment, a plurality of video cameras are provided, whose respective visual ranges each overlap in an overlapping region. Thus, this means, in particular, that here, a plurality of overlapping regions are covered, that is, in particular, monitored, by a plurality of video cameras.

The wording “or” includes, in particular, the wording “and/or.”

According to one specific embodiment, one or more or all of the video cameras are positioned at a height of at least 2 m, in particular, 2.5 m, relative to the ground of the parking area.

This produces, for example, the technical advantage that the overlapping region may be recorded efficiently.

According to one specific embodiment, the video camera(s), with the aid of which the analysis is carried out, are selected as a function of one or more processing criteria.

A technical advantage of this is, for example, that the video cameras may be selected efficiently.

According to another specific embodiment, the processing criterion or criteria are selected from the following group of processing criteria: specific computing capacity of the video cameras, specific storage capacity utilization of the video cameras, specific transmission bandwidth to the video cameras, specific power consumption of the video cameras, specific computing performance of the video cameras, specific computing speed of the video cameras, specific, current operating mode of the video cameras.

A technical advantage of this is, for example, that the video cameras may be selected efficiently.

In one specific embodiment, the processing criterion is compared to a predetermined processing criterion threshold value; the video camera or the video cameras being selected as a function of a result of the comparison.

For example, only video cameras, whose respective computing capacities are greater than or greater than or equal to a computing capacity threshold value, are selected.

For example, only video cameras, whose respective storage capacity utilizations are less than or less than or equal to a storage capacity utilization threshold value, are selected.

For example, only video cameras, to which a transmission bandwidth is greater than or greater than or equal to a transmission bandwidth threshold value, are selected.

For example, only video cameras, whose respective power consumptions are less than or less than or equal to a power consumption threshold value, are selected.

For example, only video cameras, whose respective computing performances are greater than or greater than or equal to a computing performance threshold value, are selected.

For example, only video cameras, whose respective computing speeds are greater than or greater than or equal to a computing speed threshold value, are selected.

For example, only video cameras, whose respective, current operating modes correspond to an activated operating mode, are selected. An activated operating mode is not a standby mode.

Below, the present invention is explained in further detail on the basis of preferred exemplary embodiments.

### BRIEF DESCRIPTION OF THE DRAWINGS

FIG. 1 shows a flow chart of an example method for detecting a raised object located within a parking area.

FIG. 2 shows a system for detecting a raised object located within a parking area.

FIG. 3 shows a first parking area.

FIG. 4 shows two video cameras, which monitor the ground of a parking area.

FIG. 5 shows the two video cameras of FIG. 4 during the detection of a raised object.

FIG. 6 shows a second parking area.

### DETAILED DESCRIPTION OF EXAMPLE EMBODIMENTS

In the following, identical reference numerals may be used for the same features.

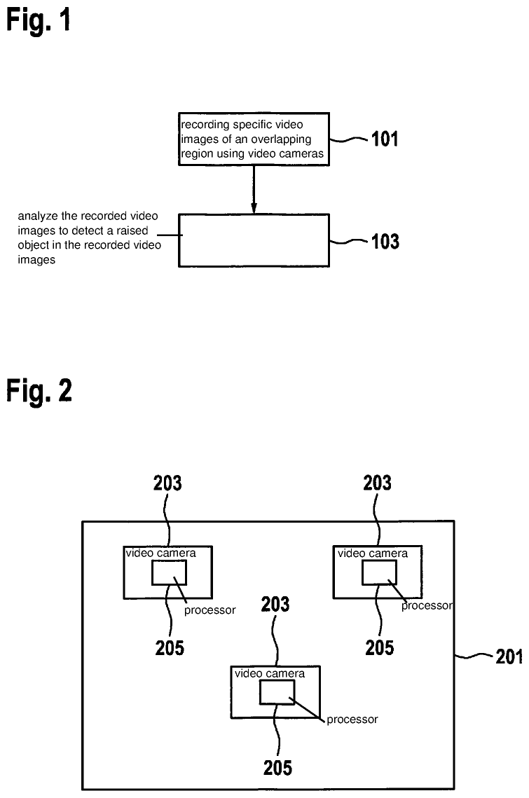

FIG. 1 shows a flow chart of an example method for detecting a raised object located within a parking area, using at least two video cameras, which are spatially distributed inside of the parking area, and whose respective visual ranges overlap in an overlapping region.

The example method includes the following steps:
recording 101 specific video images of the overlapping region, using the video cameras;
analyzing 103 the recorded video images, in order to detect a raised object in the recorded video images;
the analyzing 103 being carried out exclusively by at least one of the video cameras, inside of the video camera(s).

A detected, raised object may be classified, for example, as follows: motor vehicle, pedestrian, cyclist, animal, baby stroller, other.

FIG. 2 shows an example system 201 for detecting a raised object located within a parking area. System 201 is configured to execute or implement the method for detecting a raised object located within a parking area.

System 201 includes, for example, a plurality of video cameras 203 for recording video images, the video cameras being spatially distributed within the parking area. Video cameras 203 each include a processor 205 for analyzing the recorded video images, in order to detect a raised object in the recorded video images.

System 201 is configured, in particular, to carry out the following steps:
selecting, from the plurality of video cameras 203, at least two video cameras 203, whose respective visual ranges overlap in an overlapping region;
recording a specific video image of the overlapping region, using selected video cameras 203;
analyzing the recorded video images with the aid of a processor 205 or with the aid of a plurality of processors 205, in order to detect a raised object in the recorded video images.

The analysis of the recorded video images is carried out exclusively in one or in a plurality of the video cameras 203. An analysis by an external data processing device or an external processing unit is not provided.

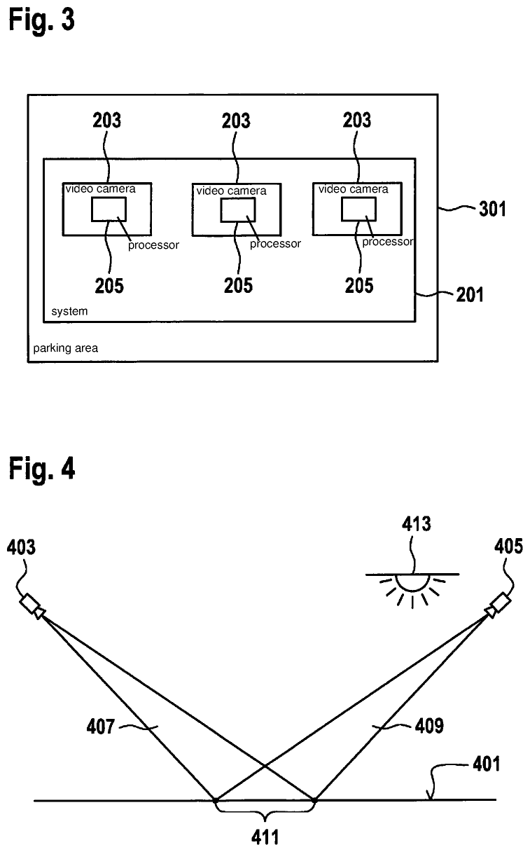

FIG. 3 shows an example parking area 301.

Parking area 301 includes the system 201 of FIG. 2.

FIG. 4 shows a first video camera 403 and a second video camera 405, which monitor the ground 401 of a parking area. The two video cameras 403, 405 are positioned, for example, on a ceiling (not shown).

First video camera 403 has a first visual range 407. Second video camera 405 has a second visual range 409. The two video cameras 403, 405 are positioned in such a manner, that the two visual ranges 407, 409 overlap in an overlapping region 411. This overlapping region 411 is part of the ground 401.

A light source 413 is situated next to second video camera 405, directly on the left; the light source illuminating overlapping region 411 from the direction of second video camera 405.

There is no raised object on the ground 401. Thus, this means that the two video cameras 403, 405 see or cover the same overlapping region 411. Thus, this means that the two video cameras 403, 405 recognize or see the same image information of overlapping region 411.

The two video cameras 403, 405 each record video images of overlapping region 411; the video images being rectified. If there is no raised object between overlapping region 411 and video camera 403 or 405, then each of the rectified video images do not differ from each other, at least not within a predefined tolerance (the predetermined tolerance value). Thus, in this case, no difference will be detected, which means that in a corresponding manner, no raised object is detected, as well.

For example, overlapping region 411 is situated on a traveling region of the parking area. Thus, this means, for example, that motor vehicles may travel on the overlapping region 411.

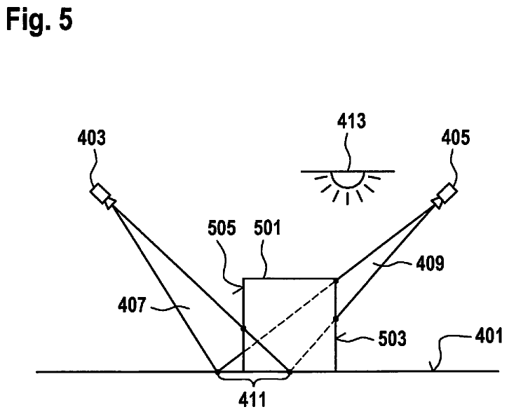

FIG. 5 shows the two video cameras 403, 405 during the detection of a raised object 501. Raised object 501 includes opposite sides 503, 505: In the following, side 503 is referred to as the right side (with respect to the plane of the paper). In the following, side 505 is referred to as the left side (with respect to the plane of the paper).

Generally, raised objects appear different from different sides. Thus, this means that raised object 501 looks different from right side 503 than from left side 505.

Raised object 501 is located on the ground 401. Raised object 501 is situated between overlapping region 411 and the two video cameras 403, 405.

First video camera 403 covers left side 505 of raised object 501. Second video camera 405 covers right side 503 of raised object 501.

Consequently, in this case, the respective, rectified video images differ, which means that a difference is correspondingly detected. Raised object 501 is then detected accordingly. In this case, the differences are greater than the predetermined tolerance value.

By providing light source 413, right side 503 is illuminated, in particular, more intensely than left side 505. This produces, for example the technical advantage that the recorded and, therefore, the rectified video images, as well, differ in their brightness. Differences in brightness may be detected efficiently, so that the difference may be detected efficiently, which means that in this connection, raised object 501 may be efficiently detected in an advantageous manner.

Raised object 501 is, for example, a motor vehicle, which is traveling on the ground 401 of the parking area. Sides 503, 505 are, for example, front and rear sides of the motor vehicle, or the right and left sides.

If a non-raised, that is, two-dimensional or flat object is situated on the ground 401, then, as a rule, the correspondingly rectified video images do not differ from each other within a predefined tolerance. An example of such a two-dimensional object is a sheet, paper or leaves. That, in such a case, an object, albeit not a raised object, is indeed located on the ground 401, which, possibly due to the lack of a difference (differences are less than or less than or equal to the predefined tolerance value), is not detected in the rectified video images, is, here, in this respect, not relevant for safety reasons, since as a rule, such non-raised objects may or can be run over by motor vehicles without a problem. Motor vehicles may run over leaves or paper, without its leading to a dangerous situation or collision, in contrast to a raised object, which may be, for example, a pedestrian or a cyclist or an animal or a motor vehicle. A motor vehicle should not collide with such objects.

Video images, which are analyzed in accordance with the above explanations in order to detect a raised object in the video images, are recorded by video cameras 403, 405.

The design of the present invention is now based on the fact that the analysis of the video images is carried out exclusively by the video cameras or by one of the video cameras alone. The video cameras transmit their recorded video images to the video camera or to the video cameras, which is or are intended to carry out the analysis. The transmission includes, for example, transmitting the video images over a communications network, which includes, for example, a wireless and/or a wired communications network.

The more video cameras that analyze the video images independently of each other, the higher the probability of a correct or reliable result, but at the cost of computing intensity, for example, a processor loading or a duration of the computations.

The information item, that an object has been detected, is signaled or transmitted, for example, to a parking area management system, which includes the parking area management server. The parking area management system uses this information, for example, for the planning or management of an operation of the parking area. Thus, the parking area management system operates the parking area, for example, on the basis of the information.

This information is used, for example, in the remote control of a motor vehicle, which is located within the parking area. Thus, this means, for example, that the parking area management system controls a motor vehicle remotely within the parking area on the basis of the detected object(s).

This information is transmitted, for example, via a wireless communications network, to motor vehicles traveling autonomously inside of the parking area.

Thus, the present invention is based on the idea of using a plurality of video cameras, which are spatially distributed within a parking area able to take the form of a parking garage, in such a manner, that, for example, every point of a traveling region is seen or covered or monitored by at least two, for example, at least three video cameras. Thus, this means that the respective visual ranges each overlap in overlapping regions; the overlapping regions covering the traveling region. The recorded video images are rectified, for example, prior to the comparison.

The corresponding, rectified video images of the video cameras are compared to each other, for example, using an image processing algorithm. For example, if all of the video cameras in the traveling region see the same image information at a particular location or at a particular point, it is determined that there is no object in the respective line of sight between the particular location and the video cameras. This being the case, an object is also not detected. However, according to one specific embodiment, if the image information of a video camera at this location differs from the other video cameras, then it is clear that a raised object must be in the line of sight of this one video camera. This being the case, an object is detected.

In the sense of this description, the phrases “the same image information” or “identical image information” also include, in particular, the case, in which the image data differ, at most, by a predetermined tolerance value. Only differences, which are greater than the predetermined tolerance value, result in the detection of an object. Thus, this means, in particular, that small differences in the brightness information and/or color information are permissible for making the statement, that the image information is the same or identical, as long as the differences are less than the predetermined tolerance value.

Thus, this means that, in particular, e.g., a tolerance is predefined, by which the rectified video images may differ, without a raised object's being detected. A raised object is only detected, if the differences are greater than the predefined tolerance.

Thus, this means, in particular, that according to one specific embodiment, an object is only detected, when the differences in the rectified video images are greater than a predefined tolerance or a predetermined tolerance value.

In particular, the design of the present invention is advantageously not model-based with regard to the objects to be detected. For example, the algorithm uses only model knowledge about the parking area, that is, where boundary surfaces of the parking area (e.g., the ground, walls or columns) are located in the traveling region.

For example, it may be provided that a motor vehicle traveling autonomously or by remote control move within the parking area on surfaces stipulated beforehand, the traveling region. The video cameras are positioned, for example, in such a manner, that their visual ranges overlap in the traveling region. This overlapping is selected in such a manner, that every point on the boundary surfaces (for example, ground, wall) in the traveling region is seen or monitored by at least three video cameras. In particular, the positioning is selected in such a manner, that every point on the boundary surface is viewed or monitored from different perspectives.

Therefore, this means, in particular, that the overlapping region is covered or recorded from different directions with the aid of the video cameras.

Now, from every single point of the boundary surface, the lines of sight to the, e.g., three video cameras, which see this point, may be tracked. Should a plurality of video cameras be available, then, for example, it is provided that three video cameras having perspectives as different as possible be selected from the plurality of cameras.

If there is no raised object in the lines of sight of the video cameras to this point, then all of the video cameras see the same image information or image data of the boundary surface, which differ, at most, by a predetermined tolerance value (cf. FIG. 4).

If, for example, a brightness or a color of the surface of the ground changes, for example, when the ground is wet due to moisture input, then this does not interfere with detection of the boundary surface, if all of the cameras see the same change in brightness or color. If, for example, a two-dimensional object, e.g., a sheet, paper, or leaves, is lying on the ground, then, as a rule, this non-raised object is not detected in accordance with the design of the present invention, since all of the video cameras see the same image information or image data, which differ, at most, by a predetermined tolerance value.

In this respect, this is not critical for safety reasons, as such two-dimensional objects may be run over by motor vehicles without any problem.

If a raised object is in the traveling region (cf. FIG. 5, for instance), then the lines of sight of the video cameras no longer reach the boundary surface (overlapping region) as expected, but the video cameras see different views of the raised object and consequently record different video images.

A raised object may be, for example, a person or a motor vehicle.

Thus, for example, one video camera sees the front side of the object, while the other video camera sees the back side of the object. As a rule, the two sides differ significantly, and the raised object may therefore be detected, if the recorded video images differ. This effect may be amplified, for example, by illuminating the scene, that is, the overlapping region, more brightly from one side, so that a failure to notice raised objects may be efficiently ruled out. By illuminating the different sides of an object differently, this object appears brighter on the more intensely illuminated side than on the weakly illuminated side, which means that the video cameras see different image data. This is even true for monochromatic objects.

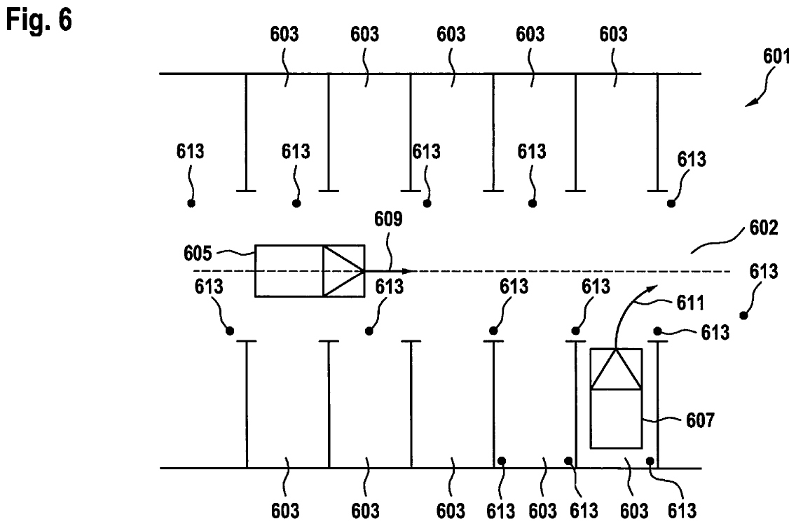

FIG. 6 shows a second parking area 601.

Parking area 601 includes several parking spaces 603, which are positioned transversely with respect to a travel path 602, on which a first motor vehicle 605 travels. A second motor vehicle 607 is parked in one of the parking spaces 603.

First motor vehicle 605 travels in the direction of arrow 609, from left to right in relation to the plane of the paper.

Second motor vehicle 607 wishes to leave a parking space, which is indicated by an arrow having the reference numeral 611.

A plurality of video cameras 613 are spatially distributed within the parking area. Video cameras 613 are drawn schematically as filled-in circles.

For example, at an edge of travel path 602, video cameras 613 are positioned on the left and right, in a staggered manner. For example, video cameras 613 are each positioned in corners of parking spaces 603.

Video cameras 613 may be positioned at a handover position, at which a driver of a motor vehicle parks his/her motor vehicle for an automatic parking operation (AVP operation; AVP=automated valet parking). Thus, the motor vehicle parked there begins the automatic parking as of the handover position. Thus, the motor vehicle travels from there automatically, in particular, autonomously or by remote control, to one of the parking spaces 103 and parks there.

Video cameras 613 may be situated at a pick-up position, at which a driver may pick up his/her motor vehicle after the end of an AVP operation. After the end of a parking period, the motor vehicle parked in a parking space 603 travels automatically, in particular, autonomously or by remote control, to the pick-up position and parks itself there.

The pick-up position may be identical to the handover position or may be different from the handover position.

Therefore, video cameras 613 allow efficient monitoring of traffic, in particular, of traffic of motor vehicles traveling automatically, that is, in particular, of motor vehicles traveling driverlessly.

The design provides detection of the motor vehicles and, on the basis of this, for example, control of the motor vehicles. For example, first motor vehicle 605 is detected. In particular, second motor vehicle 607 is detected. In particular, it is recognized that second motor vehicle 607 wishes to leave a parking space. In particular, it is recognized that first motor vehicle 605 is traveling from left to right. In particular, a possible collision is detected. In particular, second motor vehicle 607 is accordingly stopped by remote control, until first motor vehicle 605 has traveled past second motor vehicle 607.

These steps of detection are based, in particular, on the analysis of the video images of video cameras appropriately selected.

The design of the present invention advantageously allows raised objects to be detected or recognized efficiently. In particular, the design of the present invention is highly robust with respect to changes in brightness or point-to-point changes in brightness, for example, due to exposure to sunlight.

The information item, that a raised object is detected, may be transferred, for example, to a superordinate control system. For example, this control system may stop a remote-controlled motor vehicle or transmit a stop signal to a motor vehicle traveling autonomously, so that these motor vehicles may still stop in time in front of the raised object. The control system is included, for example, in the parking area management system.

Therefore, the design of the present invention may also be used in the AVP area in an advantageous manner. “AVP” stands for automated valet parking and may be translated as automatic parking operation. Within the scope of such an AVP operation, it is particularly provided that motor vehicles be parked automatically within a parking area and, after the end of a parking period, be guided automatically from its parking position to a pick-up position, at which the motor vehicle may be picked up by its owner.

1-15. (canceled)

16. A method for detecting a raised object located within a parking area, using at least two video cameras, which are spatially distributed inside of the parking area, and whose respective visual ranges overlap in an overlapping region, the method comprising:
recording specific video images of the overlapping region, using the video cameras;
analyzing the recorded video images to detect a raised object in the recorded video images;
wherein the analyzing is carried out exclusively by at least one of the video cameras, inside of the at least one of the video cameras.

17. The method as recited in claim 16, wherein the analyzing is carried out with the aid of a plurality of the video cameras, each of the plurality of video cameras analyzing the recorded video images independently of each other.

18. The method as recited in claim 16, wherein a plurality of the video cameras are spatially distributed within the parking area, and at least two of the video cameras of the plurality of video cameras are selected as the video cameras to be used, whose respective visual ranges overlap in the overlapping region.

19. The method as recited in claim 18, wherein the analyzing of the recorded video images is carried out with the aid of one or more of the selected video cameras, inside of the selected video cameras.

20. The method as recited in claim 18, wherein the analyzing of the recorded video images is carried out with the aid of one or more of non-selected ones of the video cameras, inside of the one or more of the non-selected ones of the video cameras.

21. The method as recited in claim 16, wherein the video cameras communicate among each other wirelessly and/or by wire.

22. The method as recited in claim 21, wherein the video cameras communicate among themselves, in order to decide, which of the video cameras the analyzing of the recorded video images is to be carried out.

23. The method as recited in claim 21, wherein the video cameras communicate among themselves, in order to transmit the respectively recorded video images to the at least one video camera with the aid of which the analysis is carried out.

24. The method as recited in claim 16, wherein a result of the analysis is transmitted to a parking area management server of the parking area via a communications network.

25. The method as recited in claim 16, wherein the following steps are provided for detecting the raised object in the recorded video images in accordance with the analysis:
rectifying the recorded video images;
comparing the rectified video images to each other, in order to recognize a difference in the recorded overlapping regions; and
detecting the raised object on the basis of the comparison.

26. The method as recited in claim 16, wherein the at least one of the video cameras, with the aid of which the analysis is carried out, are selected as a function of one or more processing criteria.

27. The method as recited in claim 26, wherein the one or more processing criteria are selected from the following group of processing criteria: specific computing capacity of the video cameras, specific storage capacity utilization of the video cameras, specific transmission bandwidth to the video cameras, specific power consumption of the video cameras, specific computing performance of the video cameras, specific computing speed of the video cameras, specific, current operating mode of the video cameras.

28. A system for detecting a raised object located within a parking area, using at least two video cameras, which are spatially distributed inside of the parking area, and whose respective visual ranges overlap in an overlapping region, the system configured to:
record specific video images of the overlapping region, using the video cameras;
analyze the recorded video images to detect a raised object in the recorded video images;
wherein the analyzing is carried out exclusively by at least one of the video cameras, inside of the at least one of the video cameras.

29. A parking area, including a system for detecting a raised object located within a parking area, using at least two video cameras, which are spatially distributed inside of the parking area, and whose respective visual ranges overlap in an overlapping region, the system configured to:
record specific video images of the overlapping region, using the video cameras;
analyze the recorded video images to detect a raised object in the recorded video images;
wherein the analyzing is carried out exclusively by at least one of the video cameras, inside of the at least one of the video cameras.

30. A non-transitory computer readable storage medium on which is stored a computer program including program code for detecting a raised object located within a parking area, using at least two video cameras, which are spatially distributed inside of the parking area, and whose respective visual ranges overlap in an overlapping region, the computer program, when executed by a computer, causing the computer to perform:
recording specific video images of the overlapping region, using the video cameras;
analyzing the recorded video images to detect a raised object in the recorded video images;
wherein the analyzing is carried out exclusively by at least one of the video cameras, inside of the at least one of the video cameras.
